(19) United States
(12) Patent Application Publication
(10) Pub. No.: US 2015/0223570 A1
(43) Pub. Date: Aug. 13, 2015

(54) CALIBRATION SYSTEM FOR ADJUSTING STRAPS, SUCH AS WATCH STRAPS OR SUCH AS BELTS WITH LOCKING MECHANISM

(71) Applicant: ROLAND ITEN MECHANICAL LUXURY SA, Le Mont-sur-Lausanne (CH)

(72) Inventor: Roland Iten, Le Mont-sur-Lausanne (CH)

(21) Appl. No.: 14/424,104

(22) PCT Filed: Aug. 29, 2013
(86) PCT No.: PCT/IB2013/058122

§ 371 Date: Feb. 26, 2015

(30) Foreign Application Priority Data
Aug. 30, 2012 (CH) 01556/12

(51) Int. Cl. A44B 11/12; A41F 9/02; A44C 5/00; F16H 21/44; A44B 11/20

(52) U.S. Cl. CPC A44B 11/125; F16H 21/44; A44B 11/20; A44C 5/00; A41F 9/025

(57) ABSTRACT

An adjustment system for a fine and precise adjustment of the size of a strap, such as watch strap, or belt with a part the by rotation creates a rectilinear motion of an adjustment pin that moves two parts of a strap/belt relatively to each other to adjust the length of said strap/belt. The adjustment system also comprises a locking system to block the strap in its adjusted position.

### CROSS-RELATED APPLICATION

The present application claims the benefit of the priority of Swiss patent application Number 01556/12, filed on Aug. 30, 2012 in the name of Roland ITEN, the entire disclosure of which is incorporated herein by reference.

### TECHNICAL FIELD

The present invention concerns the field of adjustable straps, such as watch strap or belts.

More specifically, the present invention concerns a calibration system allowing a fine and precise adjustment of the size of a strap such as watch strap or belt.

### BACKGROUND ART

Straps for wrist watches with clasps or buckles are known in the art and they have different shapes.

For example, FIGS. 1a to 1c illustrates a first example of a first clasp mechanism 1, 3, 6, 51 attaching the straps 5, 6 of a watch strap.

Examples of clasps/buckles allowing an adjustment of the length of the strap or buckle are for example given in the following documents: EP 1815765, EP 1981365CH 702523, WO 2008064931, GB730846.

### SUMMARY OF THE INVENTION

An aim of the present invention is to improve the known clasps and buckles of the prior art.

Another aim of the present invention is to provide a clasp that allows a fine and symmetrical adjustment of the size of the strap/belt and also a stable position and adjusted length of the strap/belt once the desired length has been chosen.

### BRIEF DESCRIPTION OF THE DRAWINGS

FIGS. 1a to 1c illustrate a clasp or buckle of the prior art.

FIGS. 2a to 2b illustrate views of the principle of an embodiment of the invention;

FIGS. 3a to 3d and FIG. 4 illustrate the functioning of an embodiment of the invention;

FIGS. 5a to 5c illustrate a further embodiment of the invention;

FIGS. 6a to 6c illustrate the functioning of the further embodiment of the invention;

FIGS. 7a to 7d illustrate elements of the further embodiment of the invention.

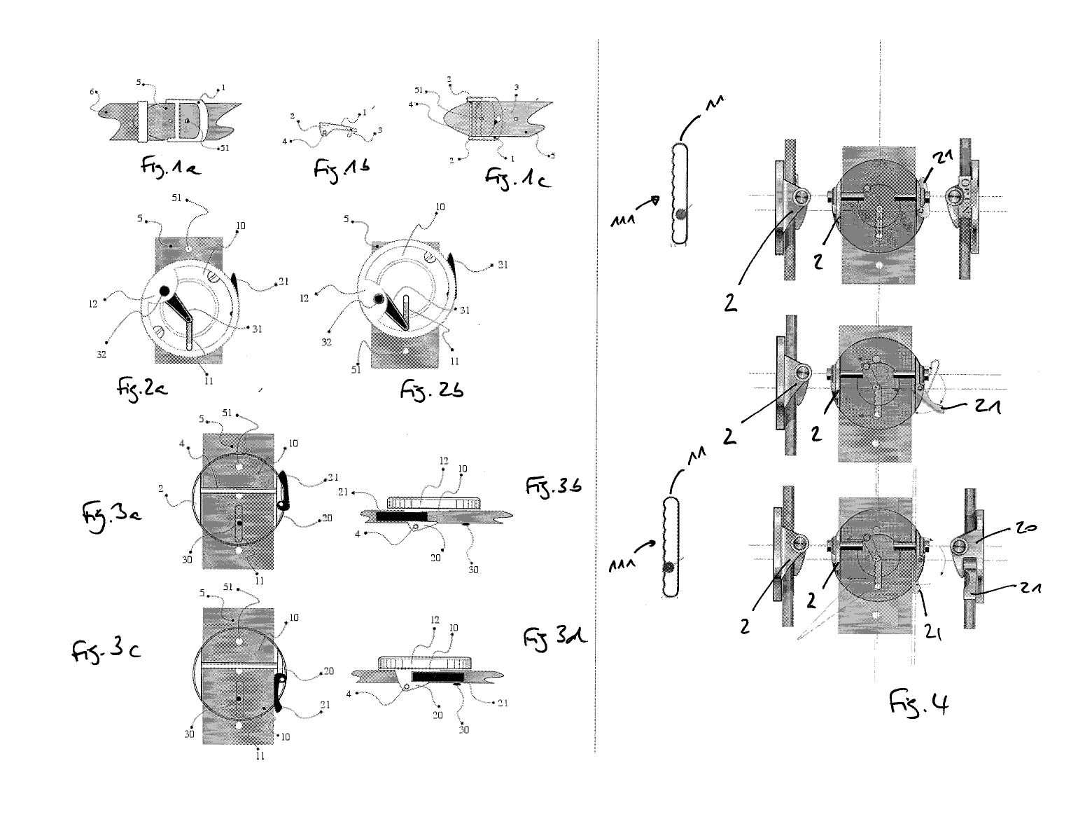

In one embodiment, the invention concerns an adjustment system for a fine and precise adjustment of the size of a strap, such as a watch strap, or a belt, said system comprising at least a rotating part cooperating with an adjustment element which is linked to a part of said strap or belt, such that the rotation of said rotating part creates a motion of said adjustment element that moves two parts of a strap/belt relatively to each other in order to adjust the overall length of said strap/belt.

In one embodiment the motion of the adjustment element may be rectilinear.

In one embodiment the adjustment element may be a pin which cooperates with a hole in a part of a strap or belt.

In one embodiment the adjustment element is linked to a rotating part via an actuating element.

In one embodiment the actuating element is articulated to a rotating part.

In one embodiment the actuating element comprises a chariot with two wheels that moves into a groove of a plate.

In one embodiment the chariot is displaced by the rotating part comprising an inner cam profile that acts on the wheels.

In one embodiment the adjustment mechanism comprises a clicking mechanism with at least a ball and a spring, wherein the clicking mechanism is attached to said plate and cooperates with openings in said rotating part.

In one embodiment, the adjustment element is guided in a groove of a plate.

In one embodiment the rotating part is mounted on the plate.

In one embodiment the system further comprises a blocking system to block the strap in the adjusted position.

In one embodiment the blocking system comprises at least a lever that acts on said strap or belt by friction.

In one embodiment the groove comprises teeth for blocking the movement of the adjustment element.

In one embodiment, the invention concerns a strap, such as a watch strap, or a belt with an adjustment system as defined herein.

In one embodiment, the invention concerns an object, such as a watch or a belt, in combination with an adjustment system as defined herein or a strap as defined herein.

### DETAILED DESCRIPTION

The invention and its embodiments will explained now by reference to the figures.

The adjustable system attached to a fixed strap or half of the belt according to the invention comprises mainly (see FIGS. 2a and 2b) a plate 10 on which is mounted a rotating part 12 to which is eccentrically connected an actuating element 31 by its end 32. The other end of the element 31 comprises a pin 30 (see FIGS. 3a-3d) which is introduced into a groove 11 of the plate 10 and also into a hole 51 of the movable part of the strap 5 or belt such that the rotation of part 12 moves the pin of the element 31 along the groove in a rectilinear motion. This thus allows to move the straps/belts parts (one fixed to the plate 10 and the other one movable) relatively to each other by a rotation of the rotating part 12 that causes a rectilinear motion of the pin 30 and the element 31 connected to the rotating part 12 which has the effect of adjusting the overall length of the strap/belt.

FIG. 2a shows a position where the overall length of the strap or belt is shorter and FIG. 2b where the overall length of the strap or belt is longer this being defined by the position of the pin 30.

FIGS. 3a to 3d illustrate a blocking mechanism to block the strap/belt once in the desired adjusted position. The blocking mechanism comprises a lever 21 articulated on the side of the adjustment system (for example on plate 10) in FIGS. 3a and 3b, the blocking mechanism is open to allow adjustment and the pin 30 may move in the groove 30. Once the desired position is reached (i.e. proper size of the strap/belt), the lever 21 is moved in the position illustrated in FIGS. 3c and 3d. In this position, the lever 21 pushes the strap/belt 5 to the left (in the figures) against wall 2 thereby pushing the pin 30 to the left as well to block the system by friction, reference 20 identifying to other side wall between which the strap/belt is positioned. In addition, it is possible to add small teeth in the groove 11 to provide an additional blocking means for the pin 30. Thus by the combination of friction of the belt and the pin 30 cooperating with said teeth in the groove, the system remains in a stable position once the desired adjustment size has been reached. The blocking position of lever 20 is a stable one created for example by the profile of the lever 20 and its rotation on an axis.

FIG. 4 further illustrate the blocking mechanism and procedure as explained in relation to FIGS. 3a-3d.

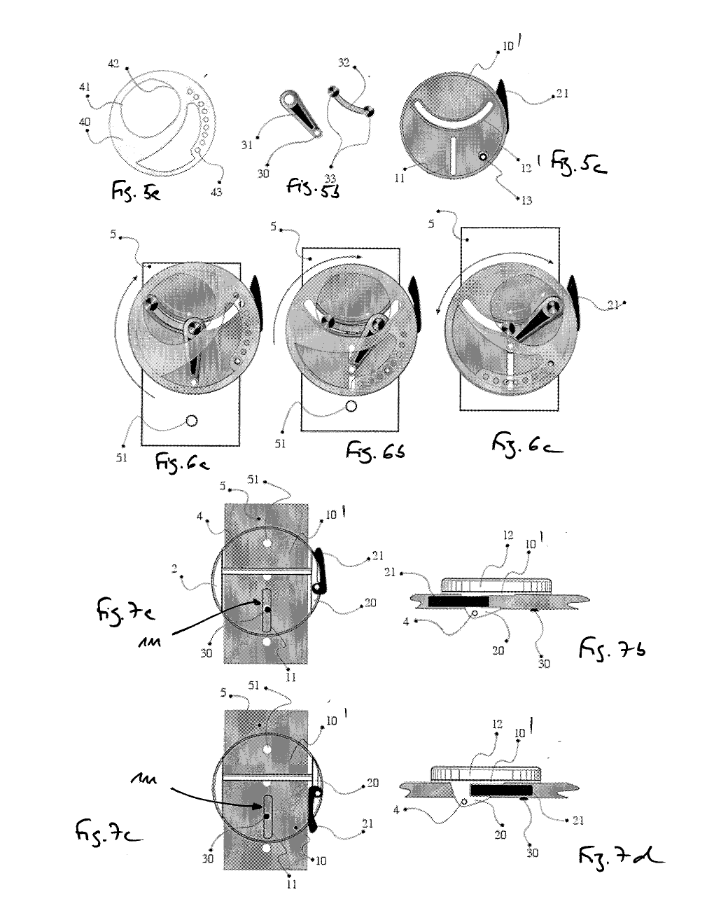

FIGS. 5a to 7d illustrates another embodiment of an adjustment system for straps or belts.

This system comprises a rotating part 40 with an inner cam profile 41, 42 and adjustment openings 43. It further comprises a lever 31 articulated on a chariot 32 which comprises two wheels 33, the lever comprising a pin 30 for the length adjustment.

It further comprises a plate 10° with a bent groove 12′ and a straight groove 11′ (as in the first embodiment) and a clicking mechanism 13′ for example a ball cooperating with a spring, the ball (once the system is assembled) cooperating with the openings 43.

The assembled system is illustrated in FIGS. 6a to 6c in different positions. Specifically, according to the principle of the present invention, the rotation of the part 40 on the plate 10′ allows a transformation into a rectilinear movement to adjust the length of the strap/belt as explained in more detail now.

In a first position, the chariot 32 is on the left side (FIG. 6a) and the lever 31 is in a position approximately vertical. By clockwise rotation of the rotating part 40 (see FIG. 6b), the chariot moves along the cam profile 42 by its wheels 33 to the position illustrated in FIG. 6b, said wheels moving in the groove 12′. In the position, the end of lever 31 (and the pin 30 it carries) has moved to about the middle of groove 11′ thus transforming a rotation movement into a rectilinear movement of the pin 30, thereby allowing an adjustment of the size of the strap/belt. To allow the movement of the chariot, wheels 33 may be made in two parts, one for the guiding in the groove 12′, and the other for moving in the cam profile 42.

FIG. 6c illustrates further position after a further clockwise rotation of the rotating part 40. Here the chariot has moved to the right side of the groove 12′ along the cam profile 42 and the end of the lever is at the top position of the groove 11. In the position, the strap/belt is in its tightest state and lever 21 is used to block the strap/belt in the chosen position, according to the principles of the present invention.

The relative motion of the part 40 (rotation) with respect to the plate 10′ therefore creates a movement of the chariot 32 as illustrated in FIGS. 6a to 6c, thus moving the lever 31 end (pin 30) in a longitudinal movement allowing the length adjustment of the strap or belt on which the system is mounted.

The clicking mechanism 13′, being applicable to all embodiments, allows a user to feel the movement of the rotating part 40 by the successive “clicks”.

In this embodiment, there is also preferably a blocking mechanism similar to the one illustrated for the first embodiment. This blocking mechanism is illustrated in FIGS. 7a to 7d. As in the first embodiment (reference is made above in the present description to the discussion in the frame of said first embodiment), a lever 21 has two positions, one (FIGS. 7a, 7b) where it allows the adjustment of the strap/belt and the other stable one (FIGS. 7c, 7d) where the strap/belt is blocked. The blocking is obtained by pressing the strap 5 to the left (in the figures) against wall 2 the blocking being due to a friction effect against wall 2. In addition, the grove 11 may comprise inner teeth 111 in against which the pin 30 is pressed to further improve the blocking effect when the lever is in its blocking position.

Of course, the blocking effect may be obtained by both the friction and the teeth 111 of the groove 11 (or 11′) or by one only of both if this is sufficient.

Other equivalent blocking means may of course be envisaged for a similar effect.

The system according to the invention thus allows a very fine and simple adjustment to the desired position by the user, by the use of simple means.

The system of the invention may be made in any suitable material, for example metals, precious metals, alloys etc.

Preferably, the system according to the invention is used with a watch strap for a wrist watch. However, the system may be used with other objects, similar or not, such a belts, helmets etc.

The examples given in the present specification are only for illustrative purposes and should not be construed in a limiting manner. Other constructions are possible using equivalent means and within the spirit and scope of the present invention.

1. An adjustment system for a fine and precise adjustment of the size of a strap, watch strap, or a belt, said system comprising at least a rotating part with an adjustment element which is linked to a part of said strap or belt, such that the rotation of said rotating part creates a motion of said adjustment element that moves two parts of a strap/belt relatively to each other in order to adjust the overall length of said strap/belt.

2. The adjustment system as defined in claim 1, wherein the motion of the adjustment element is rectilinear.

3. The adjustment system as defined in claim 1, wherein the adjustment element is a pin which cooperates with a hole in a part of said strap or belt.

4. The adjustment system as defined in claim 1, wherein said adjustment element is linked to said rotating part via an actuating element.

5. The adjustment system as defined in claim 4, wherein said actuating element is articulated to said rotating part.

6. The adjustment system as defined in claim 4, wherein said actuating element comprises a chariot with two wheels that move into a groove of a plate.

7. The adjustment mechanism as defined in claim 6, wherein said chariot is displaced by said rotating part comprising an inner cam profile that acts on said chariot.

8. The adjustment mechanism as defined in claim 6, further comprising a clicking mechanism comprising at least a ball and a spring, wherein the clicking mechanism is attached to said plate, and cooperates with openings in said rotating part.

9. The adjustment system as defined in claim 1, wherein said adjustment element is guided in a groove of a plate.

10. The adjustment system as defined in claim 1, wherein said rotating part is mounted on said plate.

11. The adjustment system as defined in claim 1, further comprising a blocking system to block the strap in the adjusted position.

12. The adjustment system as defined in claim 11, wherein said blocking system comprises at least a lever that acts on said strap or belt by friction.

13. The adjustment system as defined in claim 9, wherein said groove comprises teeth for blocking the movement of said adjustment element.

14. A strap, a watch strap, or a belt with an adjustment system as defined in claim 1.

15. An object, in combination with an adjustment system as defined in claim 1.
